(19) United States
(12) Patent Application Publication
(10) Pub. No.: US 2025/0065951 A1
(43) Pub. Date: Feb. 27, 2025

(54) STRAIGHT-LINE TRACKING OF A LAWN CARE VEHICLE

(71) Applicant: HUSQVARNA AB, Huskvarna (SE)

(72) Inventor: Matthew Albinger, Shelby, NC (US)

(21) Appl. No.: 18/813,531

(22) Filed: Aug. 23, 2024

Related U.S. Application Data
(60) Provisional application No. 63/578,849, filed on Aug. 25, 2023.

(51) Int. Cl. B62D 11/00; A01D 34/82; A01D 101/00; B62D 1/12; B62D 11/04

(52) U.S. Cl. CPC B62D 11/003; A01D 34/824; B62D 1/12; B62D 11/04; A01D 2101/00

(57) ABSTRACT

A riding lawn care vehicle is provided that includes a steering assembly including control levers that are independently movable to control respective motors to drive wheels and steer the riding lawn care vehicle in a direction of travel. The riding lawn care vehicle includes processing circuitry configured to implement a straight-line tracking in which the processing circuitry is configured to track the direction of travel of the riding lawn care vehicle. The processing circuitry is configured to perform a comparison of the direction of travel with a set direction to determine an alignment of the riding lawn care vehicle that indicates whether the riding lawn care vehicle is maintaining a straight line in the set direction. And the processing circuitry is configured to cause at least one output device to provide feedback that conveys the alignment of the riding lawn care vehicle to an operator.

### CROSS-REFERENCE TO RELATED APPLICATIONS

This application is a U.S. Non-Provisional application, which claims priority to U.S. Provisional Application No. 63/578,849 filed Aug. 25, 2023. U.S. Provisional Application No. 63/578,849 is incorporated herein by reference in its entirety.

### TECHNOLOGICAL FIELD

The present disclosure relates generally to lawn care vehicles and, in particular, to straight-line tracking of lawn care vehicles.

### BACKGROUND

Lawn care tasks are commonly performed using various tools and/or machines that are configured for the performance of corresponding specific tasks. Certain tasks, like grass cutting, are typically performed by lawn mowers. Lawn mowers themselves may have many different configurations to support the needs and budgets of consumers. Walk-behind lawn mowers are typically compact, have comparatively small engines, and are relatively inexpensive. Meanwhile, at the other end of the spectrum, riding lawn mowers, such as lawn tractors, can be quite large. Riding lawn mowers can sometimes also be configured with various functional accessories (e.g., trailers, tillers, and/or the like) in addition to grass cutting components. Riding lawn mowers provide the convenience of a riding vehicle as well as a typically larger cutting deck as compared to a walk-behind model.

By their very nature, riding lawn mowers include steering assemblies that are used to direct the movement of the riding lawn mowers. The steering assemblies often take the familiar form of a steering wheel. However, handlebar assemblies have also been used in some cases. In either of these cases, an operator may grasp either the wheel or handlebars with one hand and control steering effectively while using the other hand to operate a working assembly, accessory, or make selections on a control panel. Thus, for example, the bag dump lever, which may be behind the operator, may be actuated with one hand while the operator otherwise continues to control steering with the other hand on the wheel or handlebars.

More recently, some mowers have been provided with very short (e.g., near zero) turning radiuses. These mowers have employed separate control levers that interface with independently operated drive wheels on each respective side of the mower. When these separate control levers are employed, it is common for a drive wheel on each side of the mower to be controlled by a corresponding lever on the same side of the mower. The drive wheel is then driven forward or backward based on whether the corresponding control lever is also pushed forward or pulled backward toward the operator. The operator may therefore drive and steer the mower by simultaneous, manual control of both levers. The mower may then be stopped by returning both control levers to the neutral position.

### BRIEF SUMMARY

Many operators tend to appreciate the straight lines of a freshly cut lawn, but they do not mow frequently enough to do so in nice, parallel lines. It can also be more difficult to maintain a mower in a straight line for those mowers with independently operated drive wheels because the wheels must be driven at the same speed. In this regard, operating the wheels at the same speed, and thereby maintaining a straight line, may be difficult with separate control levers in which the control levers must be pushed forward or pulled backward by the same amount relative to their neutral position.

Example implementations of the present disclosure are directed to lawn care vehicles and, in particular, to straight-line tracking of lawn care vehicles. According to example implementations, the direction of travel of a riding lawn care vehicle is tracked to determine an alignment of the riding lawn care vehicle that indicates whether the riding lawn care vehicle is maintaining a straight line in a set direction. The riding lawn care vehicle may then be configured to provide feedback that conveys the alignment of the riding lawn care vehicle to the operator, such as by discrete light-emitting diodes (LEDs) or an electronic visual display.

The present disclosure thus includes, without limitation, the following example implementations.

Some example implementations provide a riding lawn care vehicle comprising: motors to drive wheels to cause the riding lawn care vehicle to move; a steering assembly including control levers that are independently movable to control respective ones of the motors to drive the wheels and steer the riding lawn care vehicle in a direction of travel; at least one sensor configured to provide a sensed input; at least one output device configured to provide feedback to an operator of the riding lawn care vehicle; processing circuitry configured to implement a straight-line tracking in which the processing circuitry is configured to at least: receive the sensed input from the at least one sensor; track the direction of travel of the riding lawn care vehicle from the sensed input; perform a comparison of the direction of travel with a set direction to determine an alignment of the riding lawn care vehicle that indicates whether the riding lawn care vehicle is maintaining a straight line in the set direction; and cause the at least one output device to provide the feedback that conveys the alignment of the riding lawn care vehicle to the operator.

Some example implementations provide a method of performing a straight-line tracking of a riding lawn care vehicle that includes motors to drive wheels to cause the riding lawn care vehicle to move, a steering assembly including control levers that are independently movable to control respective ones of the motors to drive the wheels and steer the riding lawn care vehicle in a direction of travel, and at least one sensor configured to provide a sensed input, the method comprising: tracking the direction of travel of the riding lawn care vehicle from the sensed input; performing a comparison of the direction of travel with a set direction to determine an alignment of the riding lawn care vehicle that indicates whether the riding lawn care vehicle is maintaining a straight line in the set direction; and causing at least one output device to provide the feedback that conveys the alignment of the riding lawn care vehicle to the operator.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1A illustrates a perspective view of a riding lawn care vehicle, according to some example implementations of the present disclosure;

FIG. 1B illustrates a top view of the riding lawn care vehicle of FIG. 1, according to some example implementations;

FIG. 2 illustrates a perspective view of a steering assembly with control levers positioned to be pulled back for rearward propulsion, according to some example implementations;

FIG. 3 is a block diagram of a riding lawn care vehicle that may correspond to the riding lawn care vehicle of FIGS. 1A, 1B and 2, according to some example implementations;

FIGS. 4A, 4B, 4C and 4D are flowcharts illustrating various steps in a method of performing a straight-line tracking of a riding lawn care vehicle.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

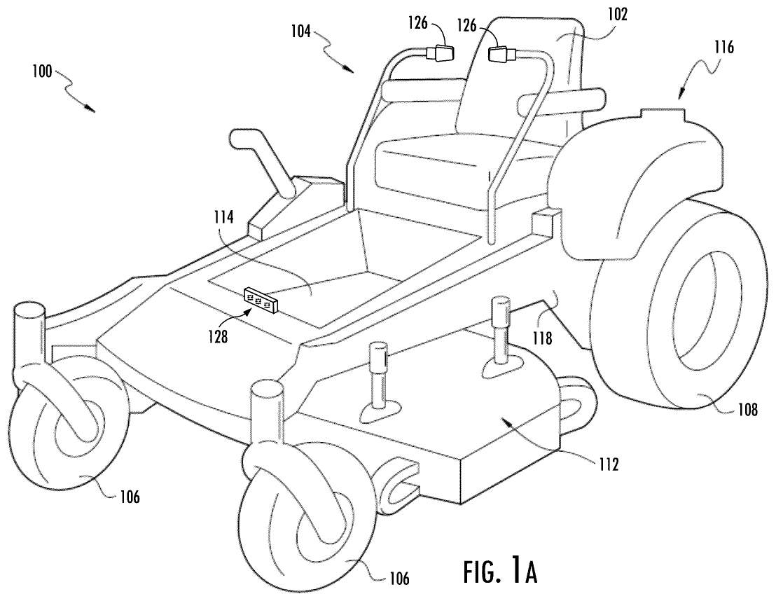

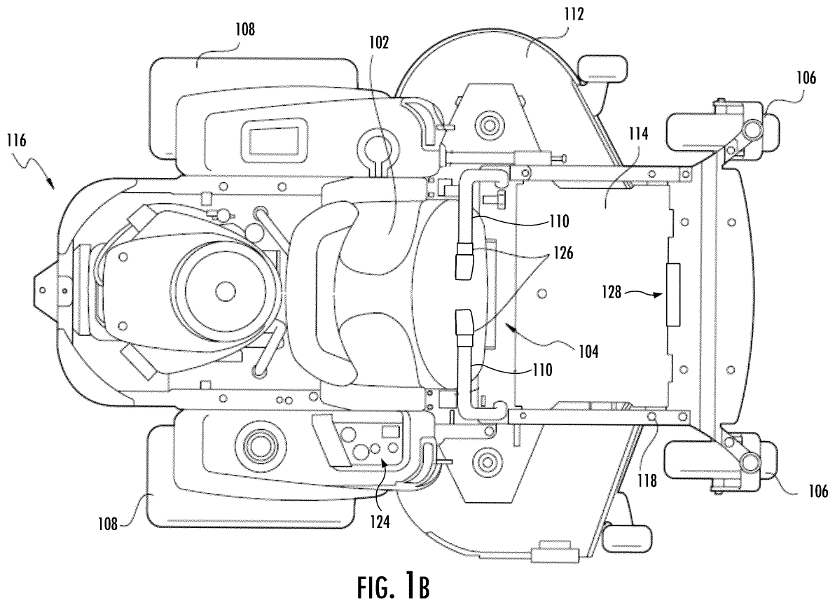

Example implementations of the present disclosure relate generally to lawn care vehicles and, in particular, to straight-line tracking of lawn care vehicles. FIG. 1A illustrates a perspective view of a riding lawn care vehicle 100, and FIG. 1B illustrates a top view of the riding lawn care vehicle such as a riding lawn mower, according to some example implementations of the present disclosure. The riding lawn care vehicle of FIGS. 1A and 1B may be recognized as an example from a class of riding lawn mowers that is often referred to as a zero-turn mower. In some implementations, the riding lawn care vehicle may include a seat 102 that may be disposed at a center, rear, or front portion of the riding lawn care vehicle. The riding lawn care vehicle may also include a steering assembly 104 functionally connected to wheels 106 and/or 108 of the riding lawn care vehicle to allow the operator to steer the riding lawn care vehicle.

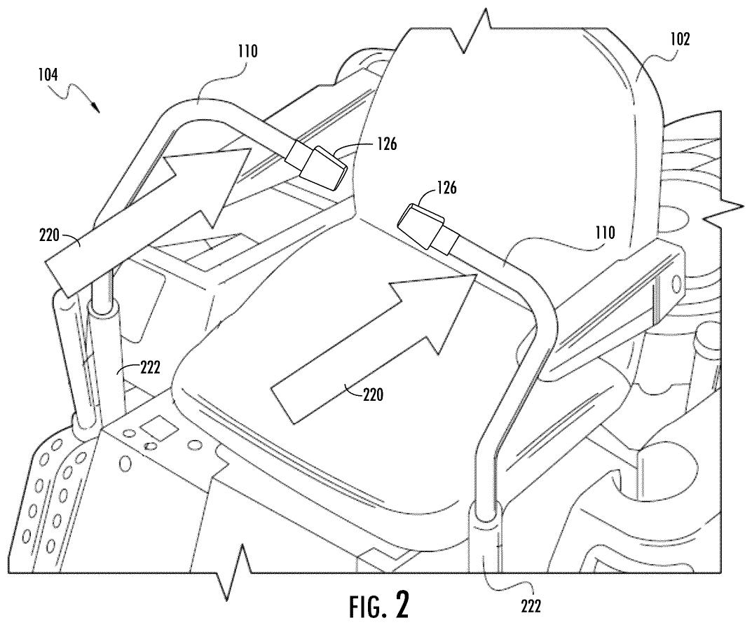

In some examples, the steering assembly 104 includes separately operable control levers 110, as shown in FIG. 1B. FIG. 2 illustrates a perspective view of a steering assembly with control levers positioned to be pulled back for rearward propulsion, according to an example implementation.

Referring to FIGS. 1A, 1B and 2, the operator may sit on the seat 102, which may be disposed to the rear of the steering assembly 104 to provide input for steering of the riding lawn care vehicle 100 via the steering assembly. However, some models may be stand-up models that eliminate the seat. If the seat is eliminated, the operator may stand at an operator station proximate to the steering assembly.

The riding lawn care vehicle 100 may also include a cutting deck 112 having at least one cutting blade (e.g., three cutting blades) mounted therein. The cutting deck may be positioned substantially rearward of a pair of front wheels 106 and substantially forward of a pair of rear wheels 108 in a position to enable the operator to cut grass using the cutting blade(s) when the cutting blade(s) are rotated below the cutting deck when the cutting deck is in a cutting position. However, in some alternative examples, the cutting deck may be positioned in front of the front wheels. In some implementations, a footrest 114 may also be positioned above the cutting deck forward of the seat 102 to enable the operator to rest his or her feet thereon while seated in the seat. In implementations that do not include the seat, the footrest may form the operator station from which a standing operator controls the riding lawn care vehicle 100. When operating to cut grass, the grass clippings may be captured by a collection system, mulched, or expelled from the cutting deck via either a side discharge or a rear discharge.

In the pictured example implementation, an engine 116 of the riding lawn care vehicle 100 is disposed to the rear of a seated operator. However, in other example implementations, the engine could be in different positions such as in front of or below the operator. In yet other example implementations, the riding lawn care vehicle may include one or more batteries, such as lithium-ion batteries, in addition to or instead of an engine.

The engine 116 (or one or more batteries) may provide power for the cutting blade(s), and a propulsion system that causes the riding lawn care vehicle to move. The propulsion system may include one or more motors that drive one or more drive wheels (e.g., rear wheels 108) on each respective side of the riding lawn care vehicle to generate propulsive forces that cause the riding lawn care vehicle to move. In some examples of the steering assembly 104, the control levers 110 may be independently movable to control respective ones of the motors.

The engine 116, the steering assembly 104, the cutting deck 112, the seat 102, and other components of the riding lawn care vehicle may be operably connected (directly or indirectly) to a frame 118 of the riding lawn care vehicle. The frame may be a rigid structure configured to provide support, connectivity, and/or interoperability functions for various ones of the components of the riding lawn care vehicle.

In some example implementations, the steering assembly 104 may be embodied as an assembly of metallic and/or other rigid components that may be welded, bolted, and/or otherwise attached to each other and operably coupled to the wheels of the riding lawn care vehicle 100 to which steering inputs are provided (e.g., rear wheels 108). For example, the steering assembly may include or otherwise be coupled with motors of the propulsion system that independently drive the one or more drive wheels.

In some more particular examples, the motors may be hydraulic motors. In some of these examples, the engine 116 drives a hydraulic pump that pressurizes hydraulic fluid that flows under control of valves to power the hydraulic motors to drive the one or more drive wheels. In other examples, the propulsion system of the riding lawn care vehicle 100 may include electric motors instead of hydraulic motors, and include motor controllers instead of motor valves. In some of these other examples, the riding lawn care vehicle may also include an electric motor to drive the cutting blade(s) of the cutting deck 112.

The control levers 110 may be stationed in a neutral position (at times referred to as a reference position), and operable to move forward (i.e., in a direction opposite the arrow 220 in FIG. 2) and rearward (i.e., in the direction shown by the arrows) from the neutral position. In some examples, each one of the control levers 110 may be operably coupled to respective lever mounts 222. The respective lever mounts may be operably coupled to a biasing assembly that tends to return the control levers to a neutral position when not being pushed or pulled away from their neutral (reference) position by the operator. In some examples, the bias assembly may permit the control levers to remain in position when fully pushed forward or fully pulled backward.

When a control lever 110 is pushed forward from the neutral position (e.g., away from the operator an opposite the direction of arrow), the corresponding motor may drive the corresponding wheel forward. When a control lever is pulled rearward from the neutral position (e.g., toward the operator as shown by the direction of arrows in FIG. 2), the corresponding motor may drive the corresponding wheel backward. The amount the control lever is pushed forward or pulled rearward from the neutral position indicates the speed at which the corresponding wheel is driven forward or backward. In the neutral position, the corresponding motor and the corresponding wheel are stationary.

When both control levers 110 are pushed forward the same amount, the riding lawn care vehicle 100 travels forward in substantially a straight line because approximately the same amount of forward drive input is provided to each drive wheel (the drive wheels are caused to move at approximately the same speed). When both control levers are pulled back the same amount, the riding lawn care vehicle travels backward (e.g., rearward) in substantially a straight line because approximately the same amount of rearward drive input is provided to each drive wheel. When one control lever is pushed forward and the other control lever is pulled back, the riding lawn care vehicle 100 begins to turn in a circle and/or spin as the drive wheels are driven to move in opposing drive directions. Steering right and left may be accomplished by providing uneven amounts of input to the control levers that drives the drive wheels to move at different speeds.

As shown in FIG. 1B, the riding lawn care vehicle 100 may further include one or more controls 124 such as buttons, levers or other actuators to regulate or guide operation of the riding lawn care vehicle. Some or all of these control(s) may be positioned on a control panel, which may be disposed on either the right or left side of the seat 102 to be readily accessible to the operator while seated. In other examples, control(s) may be positioned elsewhere on the riding lawn care vehicle to operate or control functions or operations of the riding lawn care vehicle. In particular, in some examples, either or both of the control levers 110 may include a control module 126 that includes one or more controls.

In some examples, the riding lawn care vehicle 100 may further include at least one output device configured to provide feedback to an operator of the riding lawn care vehicle. The at least one output device may include one or more of a display device 128 configured to provide the feedback in a visual form, a speaker configured to provide the feedback in an audible form, or a haptic device configured to provide the feedback in a haptic form. In some more specific examples, the display device may include one or more discrete light-emitting diodes (LEDs), an electronic visual display, or the like. Examples of suitable electronic visual displays include a liquid crystal display (LCD), light-emitting diode (LED) display, organic LED (OLED) display, active-matrix OLED (AMOLED) or the like. As shown, a display device (e.g., LEDs) may be positioned on or proximate the footrest 114. Additionally or alternatively, a display device (e.g., electronic visual display) may be positioned on at least one of the control levers 110.

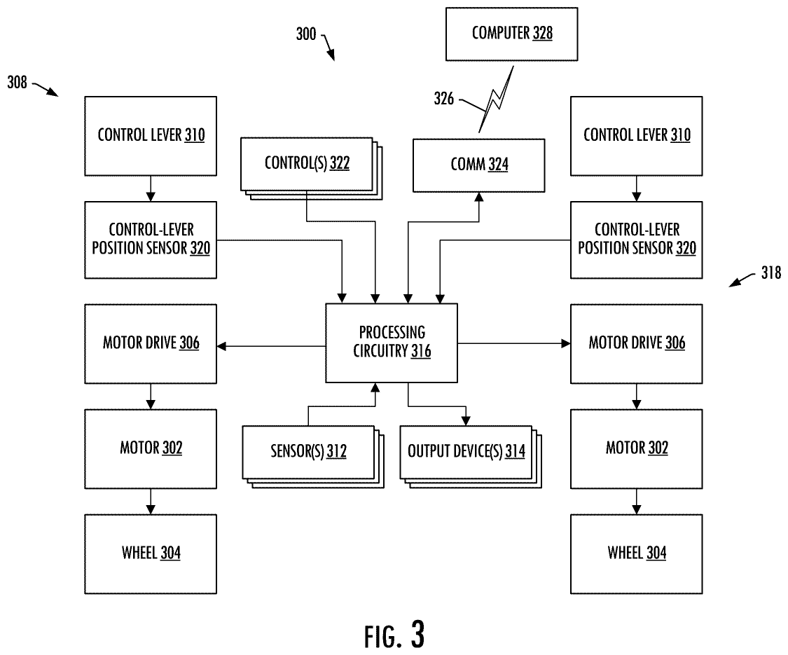

FIG. 3 is a block diagram of a riding lawn care vehicle 300 that may correspond to the riding lawn care vehicle 100 of FIGS. 1A, 1B and 2, according to some example implementations. As shown, the riding lawn care vehicle includes motors 302 to drive wheels 304 (e.g., rear wheels 108) to cause the riding lawn care vehicle to move. In some examples, the riding lawn care vehicle may include motor drives 306 configured to control operation of the motors 302. In some examples, the motors are hydraulic motors, and the motor drives are hydraulic valves. In other examples, the motors are electric motors, and the motor drives are motor controllers.

The riding lawn care vehicle 300 includes a steering assembly 308 with control levers 310 (e.g., control levers 110) that are independently movable to control respective ones of the motors 302 to drive the wheels 304 and steer the riding lawn care vehicle in a direction of travel. The riding lawn care vehicle includes at least one sensor 312 configured to provide a sensed input, and at least one output device 314 (e.g., display device 128) configured to provide feedback to an operator of the lawn care vehicle.

As also shown, the riding lawn care vehicle 300 includes processing circuitry 316, which is described in greater detail below. In some examples, the riding lawn care vehicle 300 includes a steer-by-wire control system 318 including the motors 302, the steering assembly 308 and the processing circuitry. In some of these examples, the steer-by-wire control system also includes control-lever position sensors 320 configured to detect the positions of the control levers, and provide corresponding output signals from which the processing circuitry is configured to determine the positions of the control levers. The processing circuitry may be configured to then command the motor drives 306 to control the motors to independently drive the wheels 304 based on the positions of the control levers.

According to some example implementations of the present disclosure, the processing circuitry 316 may be configured to implement a straight-line tracking of the riding lawn care vehicle 300. In this regard, the processing circuitry may be configured to receive the sensed input from the at least one sensor 312, and track the direction of travel of the riding lawn care vehicle from the sensed input. The processing circuitry may be configured to perform a comparison of the direction of travel with a set direction to determine an alignment of the riding lawn care vehicle that indicates whether the riding lawn care vehicle is maintaining a straight line in the set direction. And the processing circuitry may be configured to cause the at least one output device 314 to provide the feedback that conveys the alignment of the riding lawn care vehicle to the operator.

The at least one sensor 312 may include any of a number of different sensors that enable the processing circuitry 316 to track the direction of travel in any of a number of different manners. In some examples, the at least one sensor 312 includes at least one of speed sensors or wheel encoders for respective ones of the wheels, an inertial measurement unit (IMU), a compass, or a positioning system receiver. Examples of suitable positioning system receivers include receivers for global navigation satellite systems (GNSS) such as the Global Positioning System (GPS), GLONASS, Galileo or the like. Receivers for various regional or local positioning systems may also be suitable for some example implementations.

In some examples, the at least one sensor 312 includes speed sensors or wheel encoders configured to measure a rotational speed of respective ones of the wheels 304. In some of these examples, the processing circuitry 316 is configured to track the direction of travel based on a comparison of the rotational speed of a first of the wheels with the rotational speed of a second of the wheels. In this regard, the alignment as determined by the processing circuitry may indicate the riding lawn care vehicle 300 is maintaining the straight line when the rotational speed of the first of the wheels is the same as the rotational speed of the second of the wheels. Conversely, the alignment may indicate the riding lawn care vehicle is off the straight line when the rotational speed of the first of the wheels is different from the rotational speed of the second of the wheels. In some further examples in which the at least one sensor includes an IMU, the processing circuitry may be configured to detect slip or slide of one or more of the wheels from the sensed input from the IMU, and the alignment may indicate the riding lawn care vehicle is off the straight line when the slip or slide is detected.

As explained above, in some examples, the at least one output device 314 by which the alignment of the riding lawn care vehicle 300 is provided to the operator may include a number of different output devices that provide visual, audible or haptic feedback. In some particular examples, the at least one output device may include an electronic visual display positioned on at least one of the control levers 310, such as on a control module 126 positioned on at least one of the control levers 110. Additionally or alternatively, the at least one output device may include a display device 128 with LEDs positioned on or proximate the footrest 114.

The alignment conveyed by the feedback to the operator may indicate either the riding lawn care vehicle 300 is maintaining the straight line, or that the riding lawn care vehicle is off the straight line. In this regard, in some examples, the alignment conveyed by the feedback may indicate the riding lawn care vehicle is maintaining the straight line, responsive to the comparison in which the direction of travel is within a threshold deviation of the set direction. Conversely, the alignment conveyed may indicate the riding lawn care vehicle is off the straight line, responsive to the comparison in which the direction of travel differs from the set direction by more than the threshold deviation. And in some further examples, the alignment conveyed may further indicate whether the direction of travel is left or right of the straight line.

In some examples, the riding lawn care vehicle 300 may include a control 322 (e.g., button, lever, other actuator) that is operable to selectively enable and disable the straight-line tracking. Additionally or alternatively, the riding lawn care vehicle may include a control that is operable to set a direction as the set direction, which may be a heading of the riding lawn care vehicle when the control is operated. And in some further examples, the control may be operable to selectively enable and disable the straight-line tracking, and set the direction as the set direction when the control is operated to enable the straight-line tracking.

In some examples, the riding lawn care vehicle 300 may include controls 322 to enable a stepwise adjustment of the direction of travel and thereby the alignment of the riding lawn care vehicle. The stepwise adjustment may be set in a number of different manners. In some examples in which the feedback indicates the direction of travel is off the straight line when the deviation is greater than a threshold deviation, the stepwise adjustment may be in discrete increments that are no greater than the threshold deviation. This may allow the operator to adjust the direction of travel back to the straight line without overshooting the straight line.

The controls 322 that enable stepwise adjustment of the direction of travel may be separate and distinct from the control levers 310; but in examples in which the lawn care vehicle 300 corresponds to riding lawn care vehicle 100, the controls may be positioned on one or more of the control modules 126 located on the control levers 110. These controls in particular may be operable to control the motors 302 in steps to enable adjustment of the direction of travel, and thereby enable adjustment of the alignment of the riding lawn care vehicle, in discrete increments. In this regard, a first of the controls may be operable to control the motors in steps to enable a left adjustment of the direction of travel, and a second of the controls may be operable to control the motors in steps to enable a right adjustment of the direction of travel.

In some examples, the processing circuitry 316 may be configured to track the direction of travel, perform the comparison, and cause the at least one output device 314 to provide the feedback, when a speed of the riding lawn care vehicle 300 is at least a defined mowing speed of the riding lawn care vehicle.

In some examples, the straight-line tracking may also include the processing circuitry 316 configured to implement a turn action in which the processing circuitry is configured to control the motors 302 to drive the wheels 304 to turn the riding lawn care vehicle to a heading that is a reverse of the direction of travel. In some of these examples, the processing circuitry may be configured to implement the turn action when a speed of the riding lawn care vehicle is below a defined mowing speed of the riding lawn care vehicle. This turn action may be initiated by the operator, and the riding lawn care vehicle may include controls 322 that are operable to cause the processing circuitry to implement the turn action, left or right of the direction of travel. Similar to the controls that enable stepwise adjustment of the direction of travel, these controls may be separate and distinct from the control levers 310, but may be located on the control modules 126 located on the control levers 110.

It should be appreciated that information related to the straight-line tracking, such as one or more of the direction of travel, the set direction or the alignment, may have additional uses. For example, the information may be useful as a measure of quality of a lawn care operation of the riding lawn care vehicle 300, which may be attributed to either or both of the riding lawn care vehicle or the operator. In some examples, the riding lawn care vehicle includes a communication interface 324 to enable a wireless connection 326 between the riding lawn care vehicle and a computer 328 configured to execute application software. Examples of suitable computers include personal computers (PCs), handheld computers, mobile phones), remote controls or the like. Examples of handheld computers include mobile computers such as tablet computers, laptops and the like, mobile phones such as smartphones, wearable computers such as smartwatches, and the like.

In some of these examples, the processing circuitry 316 of the riding lawn care vehicle 300 may be configured to send information from the riding lawn care vehicle to the computer 328 over the wireless connection 326. The information may convey one or more of the direction of travel, the set direction or the alignment, for use by the application software. In this regard, the application software may use the information in a number of different manners. The application software may present the information on an electronic visual display of the computer. Additionally or alternatively, the application software may track the information over one or more lawn care operations, as a measure of quality of the lawn care operations, attributed to the riding lawn care vehicle or the operator. The application software may use the information in a game environment, or as a means by which the operator may be compared to other operators in a social media or game environment.

As described above, the processing circuitry 316 may include one or more processors alone or in combination with one or more computer-readable storage media. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in a computer-readable storage medium.

The processing circuitry 316 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

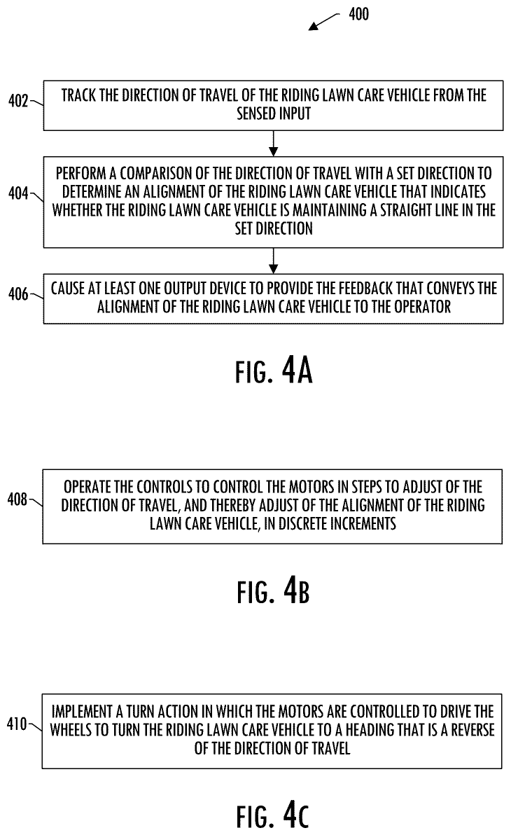

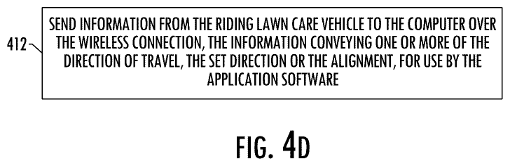

FIGS. 4A-4D are flowcharts illustrating various steps in a method 400 of performing a straight-line tracking of a riding lawn care vehicle, according to various example implementations. The riding lawn care vehicle includes motors to drive wheels to cause the riding lawn care vehicle to move a steering assembly including control levers that are independently movable to control respective ones of the motors to drive the wheels and steer the riding lawn care vehicle in a direction of travel, and at least one sensor configured to provide a sensed input. The method includes tracking the direction of travel of the riding lawn care vehicle from the sensed input, as shown at block 402 of FIG. 4A. The method includes performing a comparison of the direction of travel with a set direction to determine an alignment of the riding lawn care vehicle that indicates whether the riding lawn care vehicle is maintaining a straight line in the set direction, as shown at block 404. And the method includes causing at least one output device to provide the feedback that conveys the alignment of the riding lawn care vehicle to the operator, as shown at block 406.

In some examples, the at least one sensor includes at least one of speed sensors or wheel encoders for respective ones of the wheels, an inertial measurement unit (IMU), a compass, or a positioning system receiver.

In some examples, the at least one sensor includes speed sensors or wheel encoders configured to measure a rotational speed of respective ones of the wheels, and the direction of travel is tracked at block 402 based on a comparison of the rotational speed of a first of the wheels with the rotational speed of a second of the wheels.

In some examples, the alignment indicates the riding lawn care vehicle is maintaining the straight line when the rotational speed of the first of the wheels is the same as the rotational speed of the second of the wheels.

In some examples, the alignment indicates the riding lawn care vehicle is off the straight line when the rotational speed of the first of the wheels is different from the rotational speed of the second of the wheels.

In some examples, the at least one sensor further includes an inertial measurement unit (IMU). In some of these examples, tracking the direction of travel at block 402 includes detecting slip or slide of one or more of the wheels from the sensed input from the IMU, and the alignment indicates the riding lawn care vehicle is off the straight line when the slip or slide is detected.

In some examples, the at least one output device includes at least one display device caused to provide the feedback at block 406 in a visual form.

In some examples, the at least one display device includes an electronic visual display.

In some examples, the at least one display device includes one or more discrete light-emitting diodes (LEDs).

In some examples, the at least one display device is positioned on at least one of the control levers.

In some examples, the riding lawn care vehicle includes a footrest, and the at least one display device is positioned on or proximate the footrest.

In some examples, the at least one output device includes at least one speaker caused to provide the feedback at block 406 in an audible form.

In some examples, the at least one output device includes at least one haptic device caused to provide the feedback at block 406 in a haptic form.

In some examples, the alignment conveyed by the feedback indicates the riding lawn care vehicle is maintaining the straight line, responsive to the comparison in which the direction of travel is within a threshold deviation of the set direction.

In some examples, the alignment conveyed by the feedback indicates the riding lawn care vehicle is off the straight line, responsive to the comparison in which the direction of travel differs from the set direction by more than a threshold deviation.

In some examples, the alignment conveyed by the feedback further indicates whether the direction of travel is left or right of the straight line.

In some examples, the riding lawn care vehicle includes a control, and the method 400 further includes operating the control to selectively enable and disable the straight-line tracking.

In some examples, the riding lawn care vehicle includes a control, and the method 400 further includes operating the control to set a direction as the set direction.

In some examples, the direction that is set as the set direction is a heading of the riding lawn care vehicle when the control is operated.

In some examples, the control is operated to selectively enable and disable the straight-line tracking, and set the direction as the set direction when the control is operated to enable the straight-line tracking.

In some examples, the riding lawn care vehicle includes controls, and the method 400 further includes operating the controls to control the motors in steps to adjust of the direction of travel, and thereby adjust of the alignment of the riding lawn care vehicle, in discrete increments, as shown at block 408 of FIG. 4B.

In some further examples, a first of the controls is operated at block 408 to control the motors in steps to enable a left adjustment of the direction of travel, and a second of the controls is operated at block 408 to control the motors in steps to enable a right adjustment of the direction of travel.

In some examples, the alignment conveyed by the feedback indicates the riding lawn care vehicle is off the straight line, responsive to the comparison in which the direction of travel differs from the set direction by more than a threshold deviation. In some of these examples, the discrete increments in which the direction of travel is adjusted are no greater than the threshold deviation.

In some examples, the direction of travel is tracked at block 402, the comparison performed at block 404, and the at least one output device is caused to provide the feedback at block 406, when a speed of the riding lawn care vehicle is at least a defined mowing speed of the riding lawn care vehicle.

In some examples, the method 400 further includes implementing a turn action in which the motors are controlled to drive the wheels to turn the riding lawn care vehicle to a heading that is a reverse of the direction of travel, as shown at block 410 of FIG. 4C.

In some examples, the turn action is implemented at block 410 when a speed of the riding lawn care vehicle is below a defined mowing speed of the riding lawn care vehicle.

In some examples, the riding lawn care vehicle includes controls that are operated to implement the turn action, left or right of the direction of travel.

In some examples, the riding lawn care vehicle includes a communication interface to enable a wireless connection between the riding lawn care vehicle and a computer configured to execute application software. In some of these examples, the method 400 further includes sending information from the riding lawn care vehicle to the computer over the wireless connection, the information conveying one or more of the direction of travel, the set direction or the alignment, for use by the application software, as shown at block 412 of FIG. 4D.

As explained above and reiterated below, the present disclosure includes, without limitation, the following example implementations.

Clause 1. A riding lawn care vehicle comprising: motors to drive wheels to cause the riding lawn care vehicle to move; a steering assembly including control levers that are independently movable to control respective ones of the motors to drive the wheels and steer the riding lawn care vehicle in a direction of travel; at least one sensor configured to provide a sensed input; at least one output device configured to provide feedback to an operator of the riding lawn care vehicle; processing circuitry configured to implement a straight-line tracking in which the processing circuitry is configured to at least: receive the sensed input from the at least one sensor; track the direction of travel of the riding lawn care vehicle from the sensed input; perform a comparison of the direction of travel with a set direction to determine an alignment of the riding lawn care vehicle that indicates whether the riding lawn care vehicle is maintaining a straight line in the set direction; and cause the at least one output device to provide the feedback that conveys the alignment of the riding lawn care vehicle to the operator.

Clause 2. The riding lawn care vehicle of clause 1, wherein the at least one sensor includes at least one of speed sensors or wheel encoders for respective ones of the wheels, an inertial measurement unit (IMU), a compass, or a positioning system receiver.

Clause 3. The riding lawn care vehicle of clause 1 or clause 2, wherein the at least one sensor includes speed sensors or wheel encoders configured to measure a rotational speed of respective ones of the wheels, and the processing circuitry is configured to track the direction of travel based on a comparison of the rotational speed of a first of the wheels with the rotational speed of a second of the wheels.

Clause 4. The riding lawn care vehicle of clause 3, wherein the alignment indicates the riding lawn care vehicle is maintaining the straight line when the rotational speed of the first of the wheels is the same as the rotational speed of the second of the wheels.

Clause 5. The riding lawn care vehicle of clause 3 or clause 4, wherein the alignment indicates the riding lawn care vehicle is off the straight line when the rotational speed of the first of the wheels is different from the rotational speed of the second of the wheels.

Clause 6. The riding lawn care vehicle of any of clauses 3 to 5, wherein the at least one sensor further includes an inertial measurement unit (IMU), and wherein the processing circuitry is configured to detect slip or slide of one or more of the wheels from the sensed input from the IMU, and the alignment indicates the riding lawn care vehicle is off the straight line when the slip or slide is detected.

Clause 7. The riding lawn care vehicle of any of clauses 1 to 6, wherein the at least one output device includes at least one display device configured to provide the feedback in a visual form.

Clause 8. The riding lawn care vehicle of clause 7, wherein the at least one display device includes an electronic visual display.

Clause 9. The riding lawn care vehicle of clause 7 or clause 8, wherein the at least one display device includes one or more discrete light-emitting diodes (LEDs).

Clause 10. The riding lawn care vehicle of any of clauses 7 to 9, wherein the at least one display device is positioned on at least one of the control levers.

Clause 11. The riding lawn care vehicle of any of clauses 7 to 10, wherein the riding lawn care vehicle further comprises a footrest, and the at least one display device is positioned on or proximate the footrest.

Clause 12. The riding lawn care vehicle of any of clauses 1 to 11, wherein the at least one output device includes at least one speaker configured to provide the feedback in an audible form.

Clause 13. The riding lawn care vehicle of any of clauses 1 to 12, wherein the at least one output device includes at least one haptic device configured to provide the feedback in a haptic form.

Clause 14. The riding lawn care vehicle of any of clauses 1 to 13, wherein the alignment conveyed by the feedback indicates the riding lawn care vehicle is maintaining the straight line, responsive to the comparison in which the direction of travel is within a threshold deviation of the set direction.

Clause 15. The riding lawn care vehicle of any of clauses 1 to 14, wherein the alignment conveyed by the feedback indicates the riding lawn care vehicle is off the straight line, responsive to the comparison in which the direction of travel differs from the set direction by more than a threshold deviation.

Clause 16. The riding lawn care vehicle of clause 15, wherein the alignment conveyed by the feedback further indicates whether the direction of travel is left or right of the straight line.

Clause 17. The riding lawn care vehicle of any of clauses 1 to 16, wherein the riding lawn care vehicle further comprises a control that is operable to selectively enable and disable the straight-line tracking.

Clause 18. The riding lawn care vehicle of any of clauses 1 to 17, wherein the riding lawn care vehicle further comprises a control that is operable to set a direction as the set direction.

Clause 19. The riding lawn care vehicle of clause 18, wherein the direction that is set as the set direction is a heading of the riding lawn care vehicle when the control is operated.

Clause 20. The riding lawn care vehicle of clause 18 or clause 19, wherein the control is operable to selectively enable and disable the straight-line tracking, and set the direction as the set direction when the control is operated to enable the straight-line tracking.

Clause 21, The riding lawn care vehicle of any of clauses 1 to 20, wherein the riding lawn care vehicle further comprises controls that are operable to control the motors in steps to enable adjustment of the direction of travel, and thereby enable adjustment of the alignment of the riding lawn care vehicle, in discrete increments.

Clause 22. The riding lawn care vehicle of clause 21, wherein a first of the controls is operable to control the motors in steps to enable a left adjustment of the direction of travel, and a second of the controls is operable to control the motors in steps to enable a right adjustment of the direction of travel.

Clause 23. The riding lawn care vehicle of clause 21 or clause 22, wherein the alignment conveyed by the feedback indicates the riding lawn care vehicle is off the straight line, responsive to the comparison in which the direction of travel differs from the set direction by more than a threshold deviation, and wherein the discrete increments in which the direction of travel is adjustable are no greater than the threshold deviation.

Clause 24. The riding lawn care vehicle of any of clauses 1 to 23, wherein the processing circuitry is configured to track the direction of travel, perform the comparison, and cause the at least one output device to provide the feedback, when a speed of the riding lawn care vehicle is at least a defined mowing speed of the riding lawn care vehicle.

Clause 25. The riding lawn care vehicle of any of clauses 1 to 24, wherein the straight-line tracking further includes the processing circuitry configured to implement a turn action in which the processing circuitry is configured to control the motors to drive the wheels to turn the riding lawn care vehicle to a heading that is a reverse of the direction of travel.

Clause 26. The riding lawn care vehicle of clause 25, wherein the processing circuitry is configured to implement the turn action when a speed of the riding lawn care vehicle is below a defined mowing speed of the riding lawn care vehicle.

Clause 27. The riding lawn care vehicle of clause 25 or clause 26, wherein the riding lawn care vehicle further comprises controls that are operable to cause the processing circuitry to implement the turn action, left or right of the direction of travel.

Clause 28. The riding lawn care vehicle of any of clauses 1 to 27, wherein the riding lawn care vehicle further comprises a communication interface to enable a wireless connection between the riding lawn care vehicle and a computer configured to execute application software, and wherein the processing circuitry is further configured to send information from the riding lawn care vehicle to the computer over the wireless connection, the information conveying one or more of the direction of travel, the set direction or the alignment, for use by the application software.

Clause 29. A method of performing a straight-line tracking of a riding lawn care vehicle that includes motors to drive wheels to cause the riding lawn care vehicle to move, a steering assembly including control levers that are independently movable to control respective ones of the motors to drive the wheels and steer the riding lawn care vehicle in a direction of travel, and at least one sensor configured to provide a sensed input, the method comprising: tracking the direction of travel of the riding lawn care vehicle from the sensed input; performing a comparison of the direction of travel with a set direction to determine an alignment of the riding lawn care vehicle that indicates whether the riding lawn care vehicle is maintaining a straight line in the set direction; and causing at least one output device to provide the feedback that conveys the alignment of the riding lawn care vehicle to the operator.

Clause 30. The method of clause 29, wherein the at least one sensor includes at least one of speed sensors or wheel encoders for respective ones of the wheels, an inertial measurement unit (IMU), a compass, or a positioning system receiver.

Clause 31. The method of clause 29 or clause 30, wherein the at least one sensor includes speed sensors or wheel encoders configured to measure a rotational speed of respective ones of the wheels, and the direction of travel is tracked based on a comparison of the rotational speed of a first of the wheels with the rotational speed of a second of the wheels.

Clause 32. The method of clause 31, wherein the alignment indicates the riding lawn care vehicle is maintaining the straight line when the rotational speed of the first of the wheels is the same as the rotational speed of the second of the wheels.

Clause 33. The method of clause 31 or clause 32, wherein the alignment indicates the riding lawn care vehicle is off the straight line when the rotational speed of the first of the wheels is different from the rotational speed of the second of the wheels.

Clause 34. The method of any of clauses 31 to 33, wherein the at least one sensor further includes an inertial measurement unit (IMU), and wherein tracking the direction of travel includes detecting slip or slide of one or more of the wheels from the sensed input from the IMU, and the alignment indicates the riding lawn care vehicle is off the straight line when the slip or slide is detected.

Clause 35. The method of any of clauses 29 to 34, wherein the at least one output device includes at least one display device caused to provide the feedback in a visual form.

Clause 36. The method of clause 35, wherein the at least one display device includes an electronic visual display.

Clause 37. The method of clause 35 or clause 36, wherein the at least one display device includes one or more discrete light-emitting diodes (LEDs).

Clause 38. The method of any of clauses 35 to 37, wherein the at least one display device is positioned on at least one of the control levers.

Clause 39. The method of any of clauses 35 to 38, wherein the riding lawn care vehicle includes a footrest, and the at least one display device is positioned on or proximate the footrest.

Clause 40. The method of any of clauses 29 to 39, wherein the at least one output device includes at least one speaker caused to provide the feedback in an audible form.

Clause 41. The method of any of clauses 29 to 40, wherein the at least one output device includes at least one haptic device caused to provide the feedback in a haptic form.

Clause 42. The method of any of clauses 29 to 41, wherein the alignment conveyed by the feedback indicates the riding lawn care vehicle is maintaining the straight line, responsive to the comparison in which the direction of travel is within a threshold deviation of the set direction.

Clause 43. The method of any of clauses 29 to 42, wherein the alignment conveyed by the feedback indicates the riding lawn care vehicle is off the straight line, responsive to the comparison in which the direction of travel differs from the set direction by more than a threshold deviation.

Clause 44. The method of clause 43, wherein the alignment conveyed by the feedback further indicates whether the direction of travel is left or right of the straight line.

Clause 45. The method of any of clauses 29 to 44, wherein the riding lawn care vehicle includes a control, and the method further comprises operating the control to selectively enable and disable the straight-line tracking.

Clause 46, The method of any of clauses 29 to 45, wherein the riding lawn care vehicle includes a control, and the method further comprises operating the control to set a direction as the set direction.

Clause 47. The method of clause 46, wherein the direction that is set as the set direction is a heading of the riding lawn care vehicle when the control is operated.

Clause 48. The method of clause 46 or clause 47, wherein the control is operated to selectively enable and disable the straight-line tracking, and set the direction as the set direction when the control is operated to enable the straight-line tracking.

Clause 49. The method of any of clauses 29 to 48, wherein the riding lawn care vehicle includes controls, and the method further comprises operating the controls to control the motors in steps to adjust of the direction of travel, and thereby adjust of the alignment of the riding lawn care vehicle, in discrete increments.

Clause 50. The method of clause 49, wherein a first of the controls is operated to control the motors in steps to enable a left adjustment of the direction of travel, and a second of the controls is operated to control the motors in steps to enable a right adjustment of the direction of travel.

Clause 51. The method of clause 49 or clause 50, wherein the alignment conveyed by the feedback indicates the riding lawn care vehicle is off the straight line, responsive to the comparison in which the direction of travel differs from the set direction by more than a threshold deviation, and wherein the discrete increments in which the direction of travel is adjusted are no greater than the threshold deviation.

Clause 52. The method of any of clauses 29 to 51, wherein the direction of travel is tracked, the comparison performed, and the at least one output device is caused to provide the feedback, when a speed of the riding lawn care vehicle is at least a defined mowing speed of the riding lawn care vehicle.

Clause 53. The method of any of clauses 29 to 52, wherein the method further comprises implementing a turn action in which the motors are controlled to drive the wheels to turn the riding lawn care vehicle to a heading that is a reverse of the direction of travel.

Clause 54. The method of clause 53, wherein the turn action is implemented when a speed of the riding lawn care vehicle is below a defined mowing speed of the riding lawn care vehicle.

Clause 55. The method of clause 53 or clause 54, wherein the riding lawn care vehicle includes controls that are operated to implement the turn action, left or right of the direction of travel.

Clause 56. The method of any of clauses 29 to 55, wherein the riding lawn care vehicle includes a communication interface to enable a wireless connection between the riding lawn care vehicle and a computer configured to execute application software, and wherein the method further comprises sending information from the riding lawn care vehicle to the computer over the wireless connection, the information conveying one or more of the direction of travel, the set direction or the alignment, for use by the application software.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A riding lawn care vehicle comprising:
motors to drive wheels to cause the riding lawn care vehicle to move;
a steering assembly including control levers that are independently movable to control respective ones of the motors to drive the wheels and steer the riding lawn care vehicle in a direction of travel;
at least one sensor configured to provide a sensed input;
at least one output device configured to provide feedback to an operator of the riding lawn care vehicle;
processing circuitry configured to implement a straight-line tracking in which the processing circuitry is configured to at least:
receive the sensed input from the at least one sensor;
track the direction of travel of the riding lawn care vehicle from the sensed input;
perform a comparison of the direction of travel with a set direction to determine an alignment of the riding lawn care vehicle that indicates whether the riding lawn care vehicle is maintaining a straight line in the set direction; and
cause the at least one output device to provide the feedback that conveys the alignment of the riding lawn care vehicle to the operator.

2. The riding lawn care vehicle of claim 1, wherein the at least one sensor includes at least one of speed sensors or wheel encoders for respective ones of the wheels, an inertial measurement unit (IMU), a compass, or a positioning system receiver.

3. The riding lawn care vehicle of claim 1, wherein the at least one sensor includes speed sensors or wheel encoders configured to measure a rotational speed of respective ones of the wheels, and the processing circuitry is configured to track the direction of travel based on a comparison of the rotational speed of a first of the wheels with the rotational speed of a second of the wheels.

4. The riding lawn care vehicle of claim 3, wherein the at least one sensor further includes an inertial measurement unit (IMU), and
wherein the processing circuitry is configured to detect slip or slide of one or more of the wheels from the sensed input from the IMU, and the alignment indicates the riding lawn care vehicle is off the straight line when the slip or slide is detected.

5. The riding lawn care vehicle of claim 1, wherein the at least one output device includes at least one display device configured to provide the feedback in a visual form, and the at least one display device includes at least one of an electronic visual display or one or more discrete light-emitting diodes (LEDs).

6. The riding lawn care vehicle of claim 5, wherein the at least one display device is positioned on at least one of the control levers.

7. The riding lawn care vehicle of claim 5, wherein the riding lawn care vehicle further comprises a footrest, and the at least one display device is positioned on or proximate the footrest.

8. The riding lawn care vehicle of claim 1, wherein the riding lawn care vehicle further comprises a control that is operable to selectively enable and disable the straight-line tracking, and set a direction as the set direction when the control is operated to enable the straight-line tracking.

9. The riding lawn care vehicle of claim 1, wherein the riding lawn care vehicle further comprises controls separate and distinct from the control levers, and that are operable to control the motors in steps to enable adjustment of the direction of travel, and thereby enable adjustment of the alignment of the riding lawn care vehicle, in discrete increments.

10. The riding lawn care vehicle of claim 1, wherein the straight-line tracking further includes the processing circuitry configured to implement a turn action in which the processing circuitry is configured to control the motors to drive the wheels to turn the riding lawn care vehicle to a heading that is a reverse of the direction of travel.

11. The riding lawn care vehicle of claim 10, wherein the riding lawn care vehicle further comprises controls separate and distinct from the control levers, and that are operable to cause the processing circuitry to implement the turn action, left or right of the direction of travel.

12. A method of performing a straight-line tracking of a riding lawn care vehicle that includes motors to drive wheels to cause the riding lawn care vehicle to move, a steering assembly including control levers that are independently movable to control respective ones of the motors to drive the wheels and steer the riding lawn care vehicle in a direction of travel, and at least one sensor configured to provide a sensed input, the method comprising:
tracking the direction of travel of the riding lawn care vehicle from the sensed input;
performing a comparison of the direction of travel with a set direction to determine an alignment of the riding lawn care vehicle that indicates whether the riding lawn care vehicle is maintaining a straight line in the set direction; and
causing at least one output device to provide the feedback that conveys the alignment of the riding lawn care vehicle to the operator.

13. The method of claim 12, wherein the at least one sensor includes at least one of speed sensors or wheel encoders for respective ones of the wheels, an inertial measurement unit (IMU), a compass, or a positioning system receiver.

14. The method of claim 12, wherein the at least one sensor includes speed sensors or wheel encoders configured to measure a rotational speed of respective ones of the wheels, and the direction of travel is tracked based on a comparison of the rotational speed of a first of the wheels with the rotational speed of a second of the wheels.

15. The method of claim 14, wherein the at least one sensor further includes an inertial measurement unit (IMU), and
wherein tracking the direction of travel includes detecting slip or slide of one or more of the wheels from the sensed input from the IMU, and the alignment indicates the riding lawn care vehicle is off the straight line when the slip or slide is detected.

16. The method of claim 12, wherein the at least one output device includes at least one display device caused to provide the feedback in a visual form, and the at least one display device includes at least one of an electronic visual display or one or more discrete light-emitting diodes (LEDs).

17. The method of claim 16, wherein the at least one display device is positioned on at least one of the control levers.

18. The method of claim 16, wherein the riding lawn care vehicle includes a footrest, and the at least one display device is positioned on or proximate the footrest.

19. The method of claim 12, wherein the riding lawn care vehicle includes a control, and the method further comprises operating the control to selectively enable and disable the straight-line tracking, and set a direction as the set direction when the control is operated to enable the straight-line tracking.

20. The method of claim 12, wherein the riding lawn care vehicle includes controls separate and distinct from the control levers, and the method further comprises operating the controls to control the motors in steps to adjust of the direction of travel, and thereby adjust of the alignment of the riding lawn care vehicle, in discrete increments.

21. The method of claim 12, wherein the method further comprises implementing a turn action in which the motors are controlled to drive the wheels to turn the riding lawn care vehicle to a heading that is a reverse of the direction of travel.

22. The method of claim 21, wherein the riding lawn care vehicle includes controls separate and distinct from the control levers, and that are operated to implement the turn action, left or right of the direction of travel.
